(19) United States
(12) Patent Application Publication
(10) Pub. No.: US 2026/0238871 A1
(43) Pub. Date: Aug. 13, 2026

(54) A SYSTEM AND METHOD FOR REFERENCING A MARK DURING A SHOT USING SOFTWARE

(71) Applicant: Richard J. Schaefer, North Tustin, CA (US)

(72) Inventor: Richard J. Schaefer, North Tustin, CA (US)

(21) Appl. No.: 19/051,122

(22) Filed: Feb. 11, 2025

(51) Int. Cl. H04N 23/56; H04N 23/661

(52) U.S. Cl. CPC H04N 23/56; H04N 23/661

(57) ABSTRACT

A system that allows for a reference mark to move during the shot in the form of a light or laser with a moving camera shot. The system includes a camera that receives light from a field of view, produces signals representative of the received light, and intermittently reads the signals to create a photographic image. The intermittent reading results in intermissions between readings. The system also includes a radiant energy source that works with the camera. The radiant energy source produces a beam of radiant energy and projects the beam during intermissions between readings. The beam produces a light pattern on an object within or near the camera's field of view, thereby identifying at least a part of the field of view. The system may include both custom software code and a collection of commonly available electronic processor(s) and parts to function.

### CROSS-REFERENCES TO RELATED APPLICATIONS

N/A.

### FIELD OF THE TECHNOLOGY

The present disclosure generally relates to image recording devices and, more specifically, to video cameras and digital motion picture cameras.

### DESCRIPTION OF THE RELATED ART

A camera is a device for taking still or moving pictures. A video camera is a camera that electronically processes an image. Typically, video camera are used to take moving pictures or to photograph transient visual images. Television cameras and camcorders are examples of video cameras.

A video camera typically includes a body or enclosure, a lens, a viewfinder and a light-sensitive device which converts light into electrical signals. Light enters the camera by passing through the lens. The light which passes through the lens is either reflected or projected from objects within the camera's field of view. The camera's field of view is what the camera sees or what will be included in a photograph taken by the camera. The lens, in turn, focuses the light onto the light-sensitive device. The light-sensitive device then produces various electrical signals.

The electrical signals represent the light from the camera's field of view. The signals are then used to produce an image of the field of view in a viewfinder, on a television or both. Alternatively, the signals are used to record the image on video tape or some other media. The signals may also be used for other purposes.

Motion picture cameras are cameras that record images on film by opening and closing a shutter. Motion picture cameras also include a body or enclosure, a lens and a viewfinder. Light enters the camera through the lens and the shutter opens and closes allowing the light to strike film.

Both video cameras and motion picture cameras are aimed by looking into the camera's viewfinder and seeing the image displayed. Again, the displayed image is the camera's field of view or what the camera sees. The camera is properly aimed when the viewfinder displays the desired image.

When filming or photographing people in a shot, many times marks are used as reference to indicate physical positions that filmmakers would like the people being photographed to position themselves to. However, many times it is not possible to use a physical mark because it will also be photographed in the shot.

What is needed a system that can project a light or laser into the shot, that is intentionally synced with the cameras shutter timing, people being filmed will have a reference mark that is visible to humans but invisible to the camera(s).

### SUMMARY

In an embodiment, the present invention includes a system that allows for a reference mark to move during the shot in the form of a light or laser with a moving camera shot. The system includes a camera that receives light from a field of view, produces signals representative of the received light, and intermittently reads the signals to create a photographic image. The intermittent reading results in intermissions between readings. The system also includes a radiant energy source that works with the camera. The radiant energy source produces a beam of radiant energy and projects the beam during intermissions between readings. The beam produces a light pattern on an object within or near the camera's field of view, thereby identifying at least a part of the field of view.

In another embodiment, a device for a reference mark to move during the shot in the form of a light or laser with a moving camera shot. The device includes a camera having a pointing aid emitter that is operable by the user to produce a output beam generally aligned with the optical axis of the camera objective lens such that the output beam illuminates an object in the scene includes a timer for inhibiting repetitious operation of the emitter to reduce the risk of damage to the object that is illuminated by the beam.

In still another embodiment, a device for a reference mark to move during the shot in the form of a light or laser with a moving camera shot. The device includes an image recording apparatus (e.g. camera) includes a laser emitter which emits a beam of laser radiation towards a scene to be recorded. A movement detector detects when the image recording apparatus is being moved at or above a predetermined magnitude such that blurred images may be recorded. A controller controls an output level of laser radiation from the laser emitter. The controller enables the laser emitter to emit laser radiation when the movement detector detects movement of the image recording apparatus at or above the predetermined magnitude and disables the laser emitter from emitting laser radiation when the movement detector detects movement of the image recording apparatus below the predetermined magnitude.

### BRIEF DESCRIPTION OF THE DRAWINGS

The present invention is described in detail below with reference to the attached drawing figures, which are incorporated by reference herein and wherein:

FIG. 1 is a block diagram illustrating an exemplary embodiment of the invention;

FIG. 2 is a block diagram in accordance with another exemplary embodiment of the invention;

FIG. 3 is a system block diagram with a vehicle in accordance with another exemplary embodiment of the invention;

FIG. 4 is a block diagram in accordance with another exemplary embodiment of the invention;

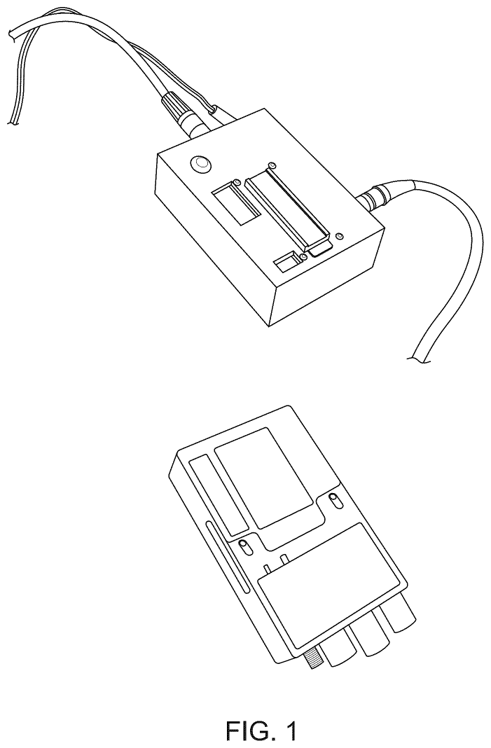

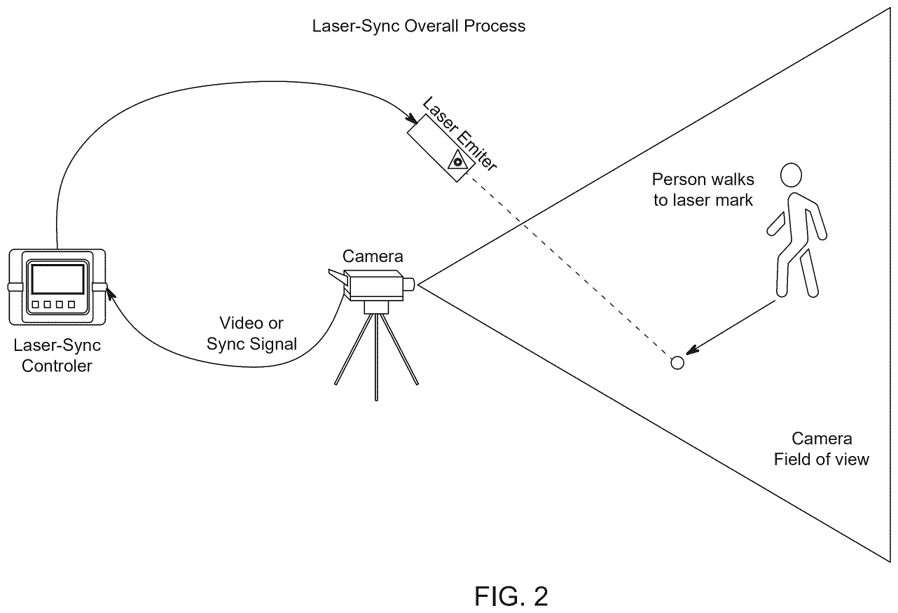

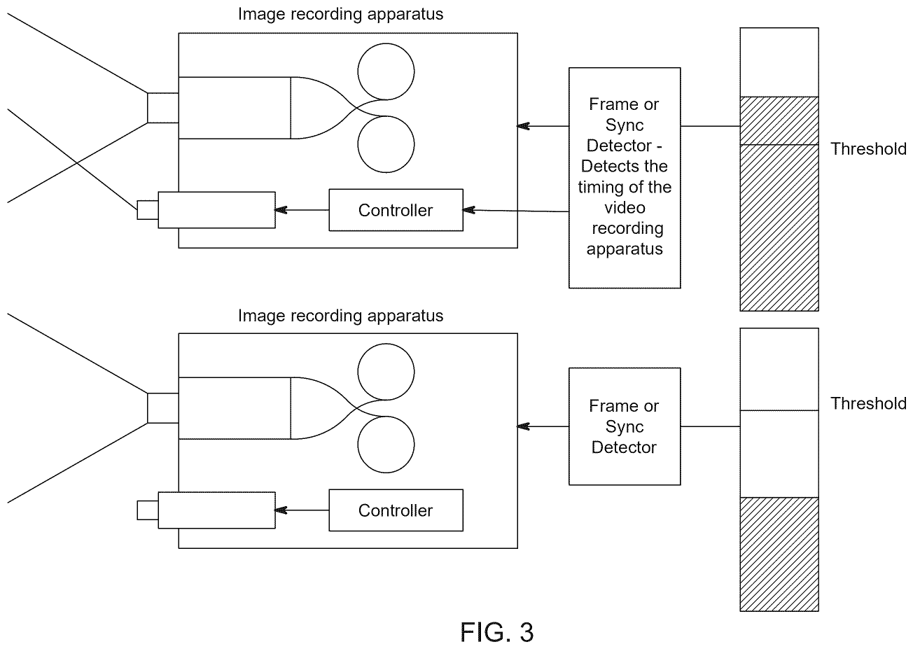

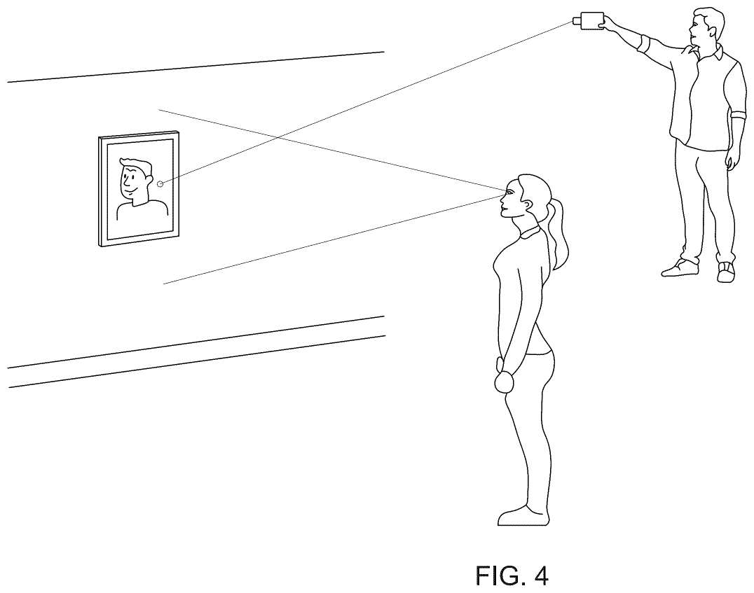

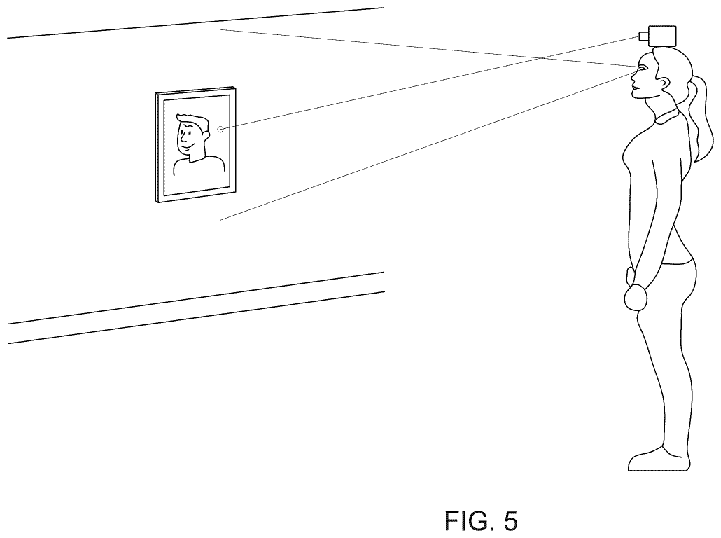

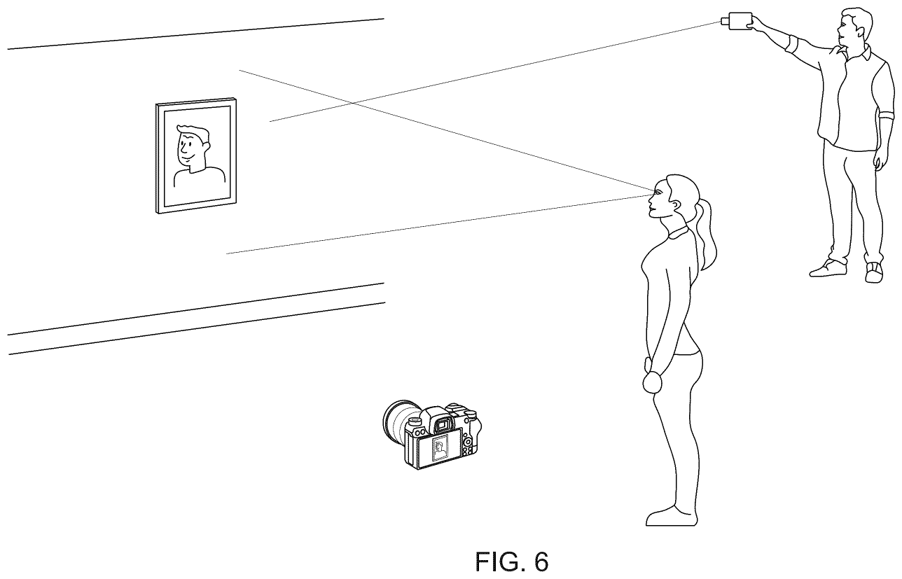

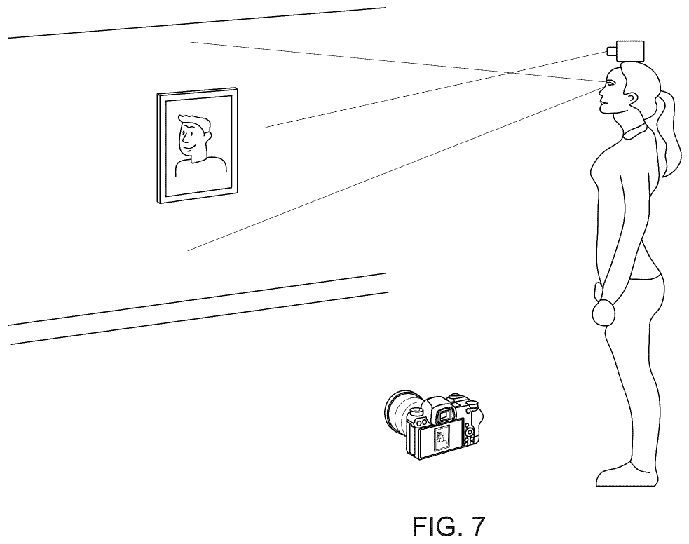

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

In some embodiments, the present invention allows for a reference mark to move during the shot in the form of a light or laser with a moving camera shot. In one embodiment, the present invention may include both custom software code and a collection of commonly available electronic processor(s) and parts to function.

In still another embodiment, the present invention can determine camera timing in multiple ways. One way is the device can read a video signal or gen-lock timing signal. It then decodes in real time the signal to determine the timing of when each frame is occurring. Another way, if the camera is equipped, is through a network or serial communication.

In yet another embodiment, once the timing is determined by the device, it adds an automatic or user defined delay, turns ON the light or laser when the camera is not capturing an image frame. Then it adds an automatic or user defined delay, then turns OFF the light or laser before the camera begins capturing the next frame.

In some embodiments, the present invention may use very specified computer code and hardware to decode and detect the very fast signals and the device very specifically turns on and off the light or laser when the cameras shutter is not exposing. All of this happens in real time. In other words, it turns on the light or laser only between the camera capturing images. Thus, the light or laser is visible to the human eye but not the camera(s) capturing images.

In an embodiment, the present invention includes a camera that receives light from a field of view, produces signals representative of the received light, and intermittently reads the signals to create a photographic image. The intermittent reading results in intermissions between readings. The invention also includes a radiant energy source that works with the camera. The radiant energy source produces a beam of radiant energy and projects the beam during intermissions between readings. The beam produces a light pattern on an object within or near the camera's field of view, thereby identifying at least a part of the field of view. The radiant energy source is often a laser and the radiant energy beam is often a laser beam. A detection mechanism that detects the intermissions and produces a signal that causes the radiant energy source to project the radiant energy beam. The detection mechanism is typically an electrical circuit including a retriggerable multivibrator or other functionally similar component. The invented method is used with a camera that is aimed toward a field of view by a light beam that produces a light pattern identifying at least a part of the field of view. The method photographs the field of view without photographing the light pattern produced by the light beam. The method includes the steps of receiving light, producing signals representative of the received light, intermittently reading the signals to create a video photograph, where the intermittent reading results in intermissions between readings, recognizing the intermission and causing the light beam to produce the light pattern during intermissions only.

In another embodiment, the present invention includes a camera having a pointing aid emitter that is operable by the user to produce a output beam generally aligned with the optical axis of the camera objective lens such that the output beam illuminates an object in the scene includes a timer for inhibiting repetitious operation of the emitter to reduce the risk of damage to the object that is illuminated by the beam. In a preferred embodiment of a still camera, the operation of the emitter is initiated by partial depression of the camera image capture button so that the beam is emitted and terminated prior to camera shutter opening. The scene captured on full depression of the image capture button is not illuminated by the beam. After light emission and is halted by release of the image capture button or time out of a maximum emission time interval, further attempts to repeat the operation of the emitter are inhibited for a set time period. In a further embodiment, a running time and maximum cumulative emission time interval are employed to allow repetitious emission of the output beam as long as the cumulative repetition time in the running time interval does not exceed the maximum cumulative time interval. The camera preferably includes an ambient light measuring system and a distance measuring system for providing automatic modulation of the power of the light beam emitted during each emission and inhibition of the emission at excessive or insufficient camera-to-object distances. The emitter preferably comprises a laser light source that produces a visible laser output beam.

In still another embodiment, the present invention includes an image recording apparatus (e.g. camera) includes a laser emitter which emits a beam of laser radiation towards a scene to be recorded. A movement detector detects when the image recording apparatus is being moved at or above a predetermined magnitude such that blurred images may be recorded. A controller controls an output level of laser radiation from the laser emitter. The controller enables the laser emitter to emit laser radiation when the movement detector detects movement of the image recording apparatus at or above the predetermined magnitude and disables the laser emitter from emitting laser radiation when the movement detector detects movement of the image recording apparatus below the predetermined magnitude.

In yet another embodiment, the present invention includes recording a video scene as seen by an observer, materializing where is focused his visual attention and allowing an external person to point at a given object in this scene, could be beneficial for various applications such as medical education or remote training. Such a versatile device, although tested at the experimental laboratory demonstrator stage, has never been integrated in a compact and portable way in a real environment. In this context, we built a low-cost, light-weight, head-mounted device integrating a miniature camera and a laser pointer that can be remotely controlled or servo-controlled by an eye tracker.

In another embodiment, the present invention may include two motorizations were implemented and tested (pan/tilt and Rilsey-prisms-based). The video was both recorded locally and transmitted wirelessly. Risley prisms allowed finer remote control of camera or laser pointer orientation (0.1° vs. 0.35°), but data processing and Wi-Fi transmission incur significant latency (~0.5 s) limiting the servo-controlling by eye movements. The laser beam was spatially shaped by a Diffractive Optical Element to facilitate object illumination or recognition. With this first proof-of-concept prototype, the data stream needs to be optimized to make full use of the eye tracker, but this versatile device can find various applications in education, healthcare or research.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A system that allows for a reference mark to move during the shot in the form of a light or laser with a moving camera shot comprising:
a camera that receives light from a field of view, produces signals representative of the received light, and intermittently reads the signals to create a photographic image;
a radiant energy source produces a beam of radiant energy and projects the beam during intermissions between readings,
wherein beam produces a light pattern on an object within or near the camera's field of view, thereby identifying at least a part of the field of view.

2. The system of claim 1, wherein the system include both custom software code and a collection of commonly available electronic processor(s).

3. The system of claim 1, wherein the system can determine camera timing in multiple ways.

4. The system of claim 1, wherein the system can read a video signal or gen-lock timing signal.

5. The system of claim 1, wherein the camera is equipped through a network communication.

6. The system of claim 1, wherein the camera is equipped through a serial communication.

7. The system of claim 1, wherein once the timing is determined by the device, it adds an automatic or user defined delay, turns ON the light or laser when the camera is not capturing an image frame.

8. A device that allows for a reference mark to move during the shot in the form of a light or laser with a moving camera shot comprising:
a camera that receives light from a field of view, produces signals representative of the received light, and intermittently reads the signals to create a photographic image;
a radiant energy source produces a beam of radiant energy and projects the beam during intermissions between readings,
wherein beam produces a light pattern on an object within or near the camera's field of view, thereby identifying at least a part of the field of view.

9. The device of claim 8, wherein the device include both custom software code and a collection of commonly available electronic processor(s).

10. The device of claim 8, wherein the device can determine camera timing in multiple ways.

11. The device of claim 8, wherein the system can read a video signal or gen-lock timing signal.

12. The device of claim 8, wherein the camera is equipped through a network communication.

13. The device of claim 8, wherein the camera is equipped through a serial communication.

14. The device of claim 8, wherein once the timing is determined by the device, it adds an automatic or user defined delay, turns ON the light or laser when the camera is not capturing an image frame.
